(19) United States
(12) Patent Application Publication
(10) Pub. No.: US 2012/0216755 A1
(43) Pub. Date: Aug. 30, 2012

(54) System For Training Dogs To Track Scents

(76) Inventor: Jason Alan Collins, Buffalo Gap, SD (US)

(21) Appl. No.: 13/034,638

(22) Filed: Feb. 24, 2011

(51) Int. Cl. A01K 29/00; B05B 9/043

(52) U.S. Cl. 119/712; 239/333

(57) ABSTRACT

A method of training a dog to track a scent, by: placing an odor-emitting substance in a solution in a pressurized fluid reservoir; carrying the pressurized fluid reservoir along a path; spraying the solution on the ground at intervals along the path by activating a hand-held spray release valve positioned mid-way along each of a pair of fluid supply lines extending from the pressurized fluid reservoir, wherein there is a sprayer at the ends of each of the fluid supply lines, and wherein one sprayer is attached to the person's left footwear and the other sprayer is attached to the person's right footwear; and; and training a dog to follow the path by having the dog detect the locations where the odor-emitting solution was sprayed on the ground.

### TECHNICAL FIELD

The present invention relates to systems for training dogs to track scents.

### SUMMARY OF THE INVENTION

The present invention provides a method and apparatus for training a dog to track a scent. In accordance with the method, this is achieved by: placing an odor-emitting substance in a solution in a pressurized fluid reservoir; carrying the pressurized fluid reservoir along a path; and spraying the solution on the ground at intervals along the path. Preferably, this spraying is done by activating a hand-held spray release valve positioned mid-way along each of a pair of fluid supply lines extending from the pressurized fluid reservoir. A sprayer is located at the ends of each of the fluid supply lines, and one sprayer is attached to the person's left shoe or boot and the other sprayer is attached to the person's right shoe or boot. Preferably, the sprayer tip is pointed inwards towards the bottom of the shoe or boot so that the spray is positioned within the footstep (i.e.: within the area of bruised vegetation).

The person walks along a path and squeezes the left and right spray-release valves when their feet touch the ground such that the sprayers spray the odor-emitting substance next to (or more preferably, right under) their footsteps. A dog is then trained to follow the path by having the dog detect the locations where the odor-emitting solution was sprayed on the ground.

Preferably, the odor in the solution is caused by bruised vegetation placed within the fluid reservoir, or by an object emitting a human odor (e.g.: an article of clothing) placed in the fluid reservoir. The dog is simply trained to follow that odor. The advantage of the present invention is that it amplifies the scent that the dog is tracking making it easier for a dog to follow. Over time, the strength/concentration of the solution can be decreased such that the dog's ability to track the scent is improved.

### BRIEF DESCRIPTION OF THE DRAWINGS

FIG. 1 is an illustration of the present apparatus.

FIG. 2 is a sectional view of the fluid reservoir.

FIG. 3 is an illustration of the present apparatus in operation showing an operator releasing the scent with every step.

FIG. 4 is an illustration of the present apparatus in operation showing an operator releasing the scent periodically.

### DETAILED DESCRIPTION OF THE DRAWINGS

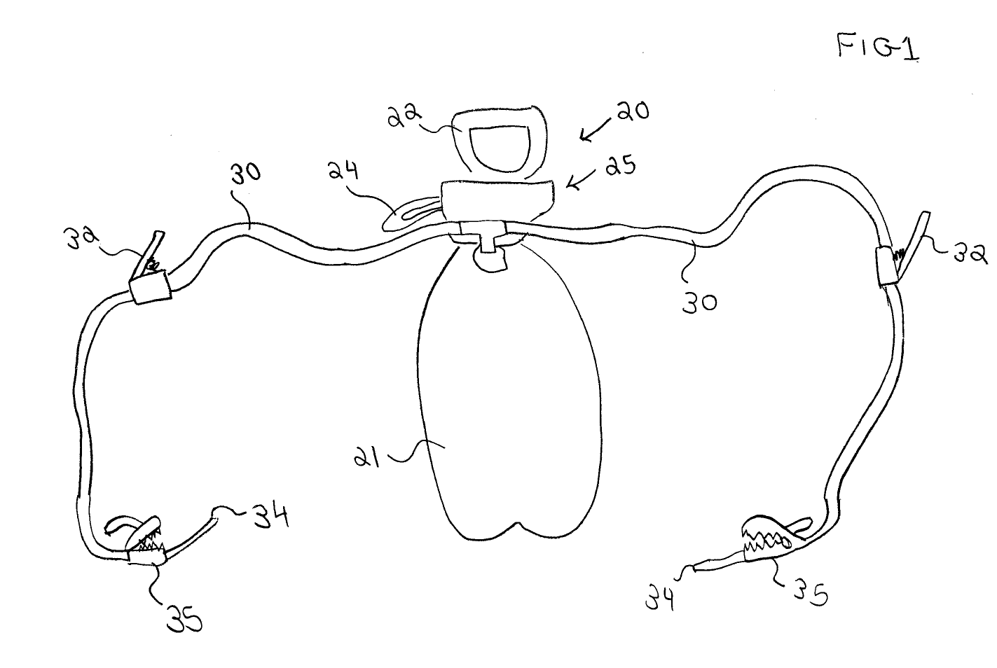

FIG. 1 illustrates the present invention, as follows. A tracking apparatus 10 is provided. Apparatus 10 comprises: a pressurized fluid reservoir 20; a pair of fluid supply lines 30 extending from pressurized fluid reservoir 20; a hand-held spray release valve 32 positioned mid-way along each of fluid supply lines 30; and a sprayer 34 positioned at an end of each of fluid supply lines 30.

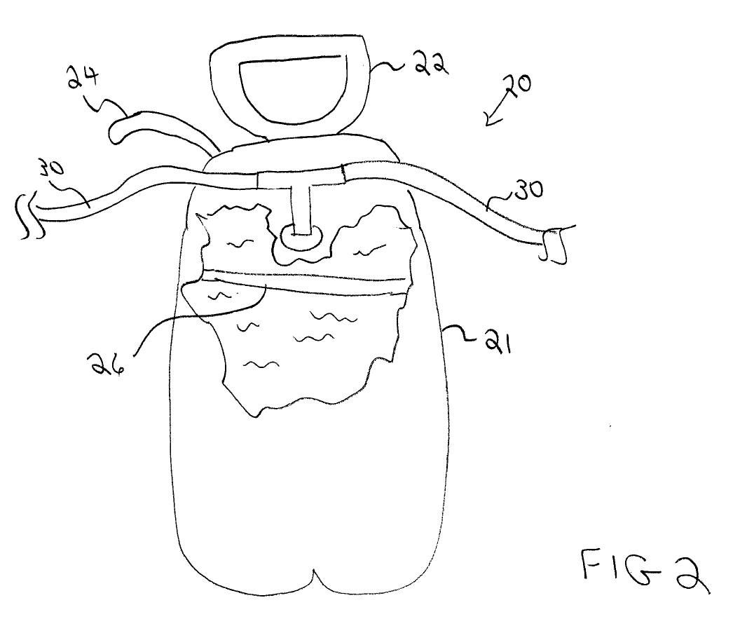

Pressurized fluid reservoir 20 comprises: a fluid reservoir 21; and a hand pump 22 for pressurizing fluid reservoir 21. An optional T-connector 25 is provided connecting the pair of fluid supply lines 30 to the pressurized fluid reservoir 20. As seen in FIG. 2, fluid reservoir 20 optionally comprises an internal strainer 26 for separating an odor emitting substance from a fluid solution in the pressurized fluid reservoir. In use, the operator fills fluid reservoir with a fluid and an odor-emitting substance.

In preferred aspects, the odor-emitting substance in the fluid comprises bruised vegetation in a solution of water. Most dogs actually naturally track animals and people by detecting the scents emitted by bruised vegetation. As animals and humans step on the ground (or serape bushes as they walk through the forest), they will bruise the vegetation. Dogs are able to detect the scents caused by the bruising of the vegetation. The present invention provides a system where the scents of bruised vegetation can be substantially increased by placing bruised vegetation within the fluid reservoir. Thus, the dog is provided with a much stronger bruised vegetation scent to track than would be the case if the person did not use the present device and merely walked along a trail, bruising the vegetation as (s)he goes.

Alternatively, the fluid in reservoir 21 may comprise a substance emitting a human odor in a solution of water. For example, an article of the person's clothing may be placed in fluid reservoir 20. In this case, the present invention provides a way to spray locations along the trail with an increased concentration of the scent from the person's clothing. Again, the dog is provided with a much stronger scent to track than would be the case if the person did not use the present device and merely walked along a trail.

Further details of the preferred method are described below.

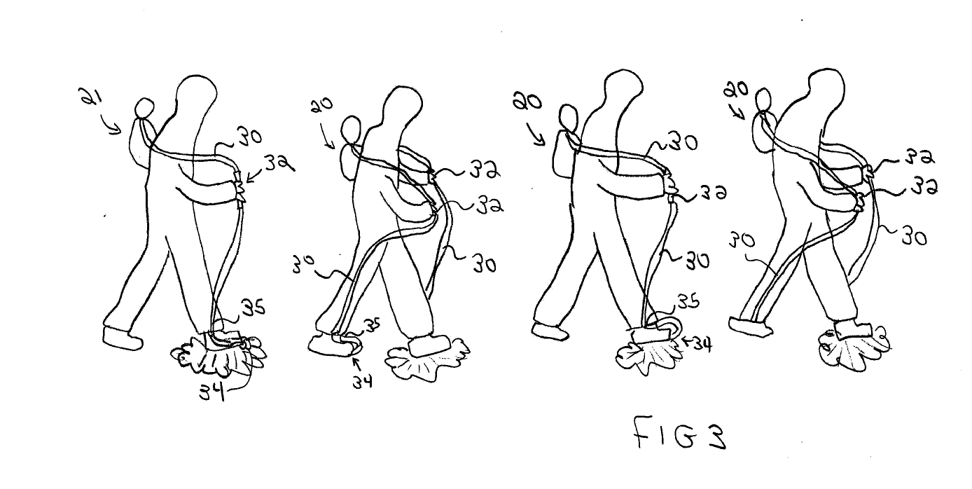

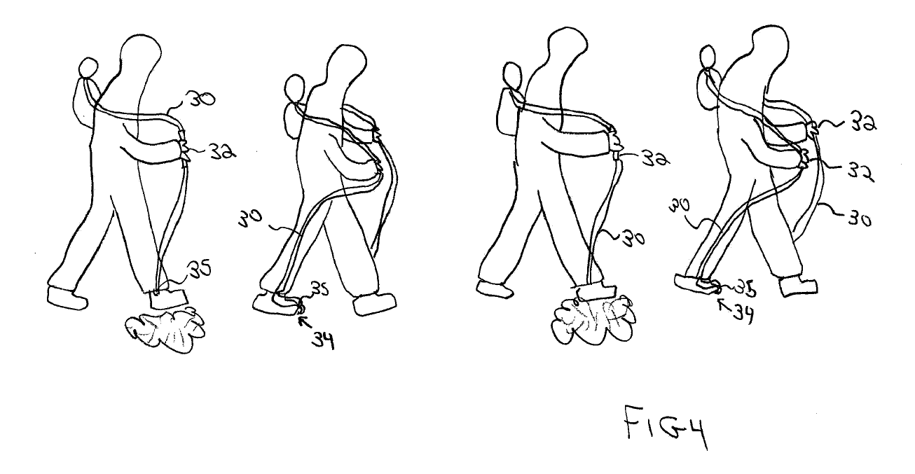

As seen in FIGS. 3 and 4, each sprayer 34 comprises a fastener 35 for attachment to the user's footwear. Preferably, the tip of sprayer 34 is pointed inwards towards the bottom of the shoe or boot so that the spray is positioned within the footstep (i.e.: within the area of bruised vegetation). As also seen, pressurized fluid reservoir 20 optionally comprises a fastener 24 for attachment to the user's belt or backpack.

In accordance with the present method, the user first places the odor-emitting substance (e.g. bruised vegetation or an article of clothing) in a water solution in pressurized fluid reservoir 20. The user can then optionally use hand pump 22 to pressurize fluid reservoir 21, such that fluid will flow out of it and through fluid supply lines 30 when released (by hand-held spray release valves 32).

Next, the user uses fasteners 35 to attach the left sprayer 34 to their left shoe or boot and the right sprayer 34 to their right shoe or boot. The tips of these sprayers are preferably positioned to spray right under the shoe or boot. Next, the user carries the pressurized fluid reservoir 20 along a path, while spraying the solution on the ground at intervals along the path. For example, when the user steps forward with their left foot, they squeeze the left hand-held spray release valve 32 so that fluid is sprayed on the ground under (or adjacent to) their left shoe or boot. Next, the user steps forward with their right foot, they squeeze the right hand-held spray release valve 32 so that fluid is sprayed on the ground under (or adjacent to) their right shoe or boot.

A dog is then trained to later follows along the sprayed trail to follow the path by having the dog detect the locations where the odor-emitting solution was sprayed on the ground.

Over time, the user can spray another scent trail, progressively decreasing the concentration of the odor-emitting substance in the solution. Alternatively, the user can spray another scent trail, progressively increasing the distances between the locations where the odor-emitting substance is sprayed on the ground over time.

FIG. 3 shows a user spraying at each success footstep. This approach can be used to train dogs that are first learning to track. FIG. 4 shows a user spraying at periodic (non-successive) footsteps. This approach spaces apart the locations where the spraying is done. It can be used for training more advanced dogs.

Moreover, when using either of the methods illustrated in FIG. 3 or 4, it is to be understood that the person doing the training can be reducing the concentration of odor causing materials in the fluid reservoir 21 over time. Thus, the present method includes decreasing the amount of sprayed scent on the path or trail both by decreasing the strength of the odor (by diluting it more), and/or by increasing the distances between where the fluid is sprayed on the ground.

What is claimed:

1. A method of training a dog to track a scent, comprising:
placing an odor-emitting substance in a solution in a pressurized fluid reservoir;
carrying the pressurized fluid reservoir along a path;
spraying the solution on the ground at intervals along the path; and
training a dog to follow the path by having the dog detect the locations where the odor-emitting solution was sprayed on the ground.

2. The method of claim 1, further comprising:
decreasing the concentration of the odor-emitting substance in the solution over time.

3. The method of claim 1, further comprising:
increasing the distances between the locations where the odor-emitting substance is sprayed on the ground over time.

4. The method of claim 1, wherein the odor-emitting substance comprises bruised vegetation.

5. The method of claim 1, wherein the odor-emitting substance comprises a substance emitting a human odor.

6. The method of claim 1, wherein spraying the solution on the ground at intervals along the path comprises spraying the solution at the locations of an operator's successive footsteps.

7. The method of claim 1, wherein spraying the solution on the ground at intervals along the path comprises the person spraying the solution at the locations of non-successive footsteps.

8. The method of claim 1, wherein the odor-emitting substance is sprayed onto the ground by a system comprising:
a pressurized fluid reservoir;
a pair of fluid supply lines extending from the pressurized fluid reservoir;
a hand-held spray release valve positioned mid-way along each of the fluid supply lines; and
a sprayer at an end of each of the fluid supply lines.

9. The method of claim 8, further comprising:
fastening the sprayer at the end of each of the fluid supply lines to an operator's footwear; and
having the operator spray the solution at locations under their footsteps by successively activating the hand-held spray release valve on each fluid supply line.

10. The method of claim 9, wherein spraying the solution at locations under the operator's footsteps comprises:
having the operator take a forward step with their left foot and spraying the solution at a location under or adjacent to where their left foot hits the ground; and
having the operator take a forward step with their right foot and spraying the solution at a location under or adjacent to where their right foot hits the ground.

11. The method of claim 1, further comprising:
pressurizing the fluid reservoir with a hand pump prior to spraying the solution.

12. An apparatus for training a dog to track a scent, comprising:
a pressurized fluid reservoir;
a pair of fluid supply lines extending from the pressurized fluid reservoir;
a hand-held spray release valve positioned mid-way along each of the fluid supply lines; and
a sprayer at an end of each of the fluid supply lines.

13. The apparatus of claim 12, wherein the pressurized fluid reservoir comprises:
a fluid reservoir; and
a hand pump for pressurizing the fluid reservoir.

14. The apparatus of claim 12, wherein each sprayer comprises a fastener for attachment to footwear.

15. The apparatus of claim 12, further comprising:
a T-connector connecting the pair of fluid supply lines to the pressurized fluid reservoir.

16. The apparatus of claim 12, wherein the pressurized fluid reservoir comprises a fastener for attachment to a belt or backpack.

17. The apparatus of claim 12, further comprising a fluid in the fluid reservoir.

18. The apparatus of claim 17, wherein the fluid comprises bruised vegetation in a solution of water.

19. The apparatus of claim 17, wherein the fluid comprises a substance emitting a human odor in a solution of water.

20. The apparatus of claim 12, wherein the pressurized fluid reservoir comprises an internal strainer for separating an odor emitting substance from a fluid solution in the pressurized fluid reservoir.
